(19) United States
(12) Patent Application Publication
(10) Pub. No.: US 2024/0251172 A1
(43) Pub. Date: Jul. 25, 2024

(54) METHOD FOR PROCESSING PIXEL DATA, CORRESPONDING DEVICE AND PROGRAM

(71) Applicant: UNIVERSITÉ DE BOURGOGNE, DIJON (FR)

(72) Inventors: Dominique GINHAC, Thorey en plaine (FR); Barthélémy HEYRMAN, QUETIGNY (FR); Steven TEL, DIJON (FR)

(21) Appl. No.: 18/565,698

(22) PCT Filed: Jun. 1, 2022
(86) PCT No.: PCT/EP2022/064985

§ 371 Date: Nov. 30, 2023

(30) Foreign Application Priority Data
Jun. 2, 2021 (FR) FR2105800

(51) Int. Cl. H04N 23/741

(52) U.S. Cl. CPC H04N 23/741

(57) ABSTRACT

The invention relates to a method for generating a video stream comprising a set of high dynamic range images, called HDR video stream, from a plurality of standard dynamic range images that are obtained by reading at least two image sensors each having an image production rate, each sensor comprising a plurality of pixels arranged in a matrix, and each associated with a photoelectric conversion element for converting received light into electric charge and accumulating said electric charge over a light exposure time, said method comprising a plurality of iterations of creating high dynamic range images comprising determining exposure times, reading optical sensors and combining the data from these sensors in an iterative operating mode involving temporary memory area management.

### 1. FIELD

The field of the disclosure is that of the acquisition of images by means of capture devices such as mobile communication terminals, digital cameras, cameras, microscopes, etc. More specifically, the disclosure relates to a method for acquiring high dynamic range (HDR) images.

It is applicable particularly, but not exclusively, in the field of cinema, video surveillance, air or road transport, non-destructive testing, in the medical field, or also in that of fundamental sciences such as physics, astronomy, etc.

### 2. PRIOR ART

The reproduction performances of the existing image capture devices are, for mainly economical reasons, limited by their narrow dynamic range. Consequently, when a scene to be captured, in the form of a still image or video, has strong contrasts, the image reproduced by the capture device may have overexposed areas, wherein the pixels of the image are saturated, corresponding to very bright areas of the scene, and of dark areas, with little or no visible details corresponding to poorly lit areas of the scene.

To solve this problem and to generate, from existing capture devices, high dynamic range images, called HDR images, a conventional technique consists in combining a plurality of traditional images, called LDR (Low Dynamic Range), associated with different exposure times. The scene to be reproduced is captured a plurality of times, by the same capture device, with different exposure times: short exposure times make it possible not to saturate the very bright areas of the image, and long exposure times make it possible to detect a useful signal in the less bright areas. The various LDR images obtained are subsequently processed to extract from each of them the best represented parts of the image, and these various parts are combined to construct an HDR image of the scene. It is generally accepted that this method for generating HDR images is costly in terms of time and number of exposures to be performed. Therefore, it is accepted that it is also not suitable for generating an HDR video sequence, due to its non “real-time” nature: the processing times would be such that they would not make it possible to reproduce an HDR image in real time.

Furthermore, it is also accepted that when the scene to be photographed comprises moving elements, the latter may occupy different positions in the various captured LDR images, which may result in the appearance of artefacts during the generation of HDR images. These ghost effects can be corrected before reconstructing the HDR image, but at the expense of complex and costly electronic processing. An algorithm for eliminating these artefacts is described, for example, by Mustapha Bouderbane et al. in the article “Ghost artifact removal for real-time HDR video generation”, Compas'2016: Parallelism/Architecture/System, Lorient, France, 5-8 Jul. 2016.

However, the development of sensors mounted on image capture devices now makes it possible for them to operate in “Non-Destructive Read Out” (NDRO) mode. In this operating mode, the electric charges accumulated by the photoelectric conversion elements of the sensor can be read, without it being necessary to reset them: it is therefore possible, during the exposure time of the sensor, to carry out a plurality of readouts of the signals of the pixels, by allowing the electric charges to continue to accumulate, under the effect of the exposure of the sensor to the light. The use of this non-destructive read out mode, which makes it possible to carry out a plurality of readouts of the signals associated with the pixels of the sensor during a single exposure time, offers an interesting solution, both in terms of the problem of time cost of the earlier methods for generating HDR images, and of the problem of the appearance of artefacts. Indeed, it is possible to generate a high dynamic image of a scene from a plurality of images obtained by a plurality of successive non-destructive readouts of the sensor during the same exposure time.

Thus, the patent document U.S. Pat. No. 7,868,938 proposes a new type of image capture device, wherein a first reader operates in destructive read out mode to read the charges accumulated by the photoelectric conversion elements of the sensor, by resetting the signals of the pixels after each readout, at the end of a standard exposure time, and a second reader operates in non-destructive read out mode to obtain a plurality of NDRO images associated with various short exposure times, that is to say shorter than the standard exposure time. The various NDRO images associated with short exposure times are used to predict whether certain pixels of the image obtained by the first reader will be saturated, due to an overexposure of the corresponding parts of the scene to be photographed during the standard exposure time. If such is the case, an HDR image is generated wherein the saturated pixels of the image obtained by the first reader in the standard exposure time are replaced by the corresponding non-saturated pixels extracted from an NDRO image associated with a shorter exposure time. This solution partially solves the exposure problems, particularly in that the overexposed pixels may be replaced by less exposed pixels, and the dynamic range of the image obtained is a little extended. But, this method requires too much computing power, does not correct the underexposure problems and above all requires at least two readouts: one destructive and the others non-destructive. Moreover, the problem of presence of artefacts is not solved.

In order to particularly solve the underexposure problems of the patent document U.S. Pat. No. 7,868,938, the document FR3062009A1 proposes a technique that would make it possible to generate a high dynamic range image that is less costly, both in terms of time and computing power and that would have the advantage of being adaptive. In this document, it is proposed to perform a plurality of non-destructive readouts of one and the same sensor, and to adapt the replacement of pixels of a current image with pixels of a following image depending on quality criteria. This method is effectively more efficient in terms of dynamic range width. On the other hand, this method does not make it possible to carry out a reproduction of the stream in real time and even so implements relatively important resources, particularly regarding the calculations of signal-noise ratios for determining the exposure times. Moreover, this method requires using a sensor making a non-destructive readout possible, a sensor that is not widely available on the market and that is significantly more expensive. For example, the method implemented in the patent document FR3062009A1 requires the use of an NSC1201 sensor from New Imaging Technologies, and is therefore reserved for specific uses.

### 3. SUMMARY

The disclosure meets this need by proposing a method for generating a video stream comprising a set of high dynamic range images, called HDR video stream, from a plurality of standard dynamic range images that are obtained by reading at least two image sensors each having an image production rate, each sensor comprising a plurality of pixels arranged in a matrix, and each associated with a photoelectric conversion element for converting received light into electric charge and accumulating said electric charge over a light exposure time, said method comprising a plurality of iterations of creating high dynamic range images comprising determining exposure times, reading optical sensors and combining the data from these sensors in an iterative operating mode involving temporary memory area management.

More particularly, it is proposed a method for generating a video stream comprising a set of high dynamic range images, called HDR video stream, from a plurality of standard dynamic range images that are obtained by reading at least two image sensors each having an image production rate, each sensor comprising a plurality of pixels arranged in a matrix, and each associated with a photoelectric conversion element for converting received light into electric charge and accumulating said electric charge over a light exposure time. According to the disclosure, such a method comprises a plurality of iterations of creating high dynamic range images comprising:

determining at least three sensor exposure times comprising: a short exposure time TC, a long exposure time TL and an intermediate exposure time TI, such that TC<TI<TL;
at least one iteration of reading sensors, from said at least two sensors, delivering at least three successive images, depending on said at least three sensor exposure times;
saving, within at least three dedicated memory areas, said at least three successive images, each memory area being dedicated to a sensor exposure time from said at least three sensor exposure times;
generating a high dynamic range image from information extracted from said at least three successive images saved respectively within said at least three dedicated memory areas;
adding said high dynamic range image to said HDR video stream.

Thus, using a reduced number of sensors, it is possible to effectively create a high quality HDR image stream, and this by maintaining intact the initial frequency for producing the images of the sensors used.

According to a particular feature, that said determination of said at least three sensor exposure times comprises determining the intermediate exposure time TI depending on said short exposure time TC and on the long exposure time TL.

Thus, for each image, it is possible to rapidly assign a satisfactory exposure time for producing the HDR stream.

According to a particular feature, the short exposure time is calculated so that it produces, during the reading of a sensor from said at least two sensors, a standard dynamic range image of which a percentage of white-saturated pixels is less than a predetermined threshold.

According to a particular feature, the long exposure time is calculated so that it produces, during the reading of a sensor from said at least two sensors, a standard dynamic range image of which a percentage of black-saturated pixels is less than a predetermined threshold.

According to a particular feature, the intermediate exposure time is obtained as the square root of the product of the short exposure time and of the long exposure time.

According to a particular feature, the long exposure time is less than the image production rate of at least one of said sensors from said at least two sensors.

Thus, it is ensured that the image rate produced remains constant, regardless of the exposure time.

According to a particular feature, the generation of a high dynamic range image of a current iteration of creating a high dynamic range image is implemented from information extracted from at least three current successive images is implemented at the same time as said at least three iterations of reading sensors, from said at least two sensors, delivering at least three successive images of the following iteration of creating a high dynamic range image.

According to a particular feature, the image rate of the HDR stream is at least equal to the image rate of at least one image sensor from the said at least two image sensors.

According to a particular example of embodiment, the disclosure is presented in the form of a device, or of a system, for generating a video stream comprising a set of high dynamic range images, called HDR video stream, from a plurality of standard dynamic range images that are obtained by reading at least two image sensors each having an image production rate, each sensor comprising a plurality of pixels arranged in a matrix, and each associated with a photoelectric conversion element for converting received light into electric charge and accumulating said electric charge over a light exposure time, characterised in that it comprises a calculation unit adapted to implement the steps of the method for generating an HDR video stream according to the method described.

According to a preferred implementation, the various steps of the methods according to the disclosure are implemented by one or more software or computer programs, comprising software instructions intended to be executed by a data processor of an execution device according to the disclosure and being designed to control the execution of various steps of the methods, implemented at a communication terminal, an electronic execution device and/or a control device, within the scope of a distribution of the processes to be carried out and determined by a scripted source code and/or a compiled code.

Consequently, the aim of the disclosure is also programs, likely to be executed by a computer or by a data processor, these programs including instructions to control the execution of steps of the method such as mentioned above.

A program may use any programming language, and be in the form of source code, object code, or byte code between source code and object code, such as in a partially compiled form, or in any other desirable form.

The aim of the disclosure is also an information medium that can be read by a data processor, and including instructions of a program such as mentioned above.

The information medium may be any entity or device capable of storing the program. For example, the medium may include a storage means, such as a ROM, for example a CD ROM or a microelectronic circuit ROM, or also a magnetic recording means, for example a mobile medium (memory card) or a hard drive or an SSD.

On the other hand, the information medium may be a transmissible medium such as an electrical or optical signal, which may be routed via an electrical or optical cable, by radio or by other means. The program according to the disclosure may in particular be downloaded on an Internet type network.

Alternatively, the information medium may be an integrated circuit wherein the program is incorporated, the circuit being adapted to execute or to be used in the execution of the method in question.

According to one embodiment, the disclosure is implemented by means of software and/or hardware components. In this regard, the term “module” may correspond in this document to a software component as well as to a hardware component or to a set of software and hardware components.

A software component corresponds to one or more computer programs, one or more subprograms of a program, or more generally to any element of a program or of software capable of implementing a function or a set of functions, according to what is described below for the module concerned. Such a software component is executed by a data processor of a physical entity (terminal, server, gateway, set-top-box, router, etc.) and is likely to access the hardware resources of this physical entity (memories, recording media, communication bus, input/output electronic cards, user interfaces, etc.).

In the same manner, a hardware component corresponds to any element of a hardware assembly capable of implementing a function or a set of functions, according to what is described below for the module concerned. This may concern a hardware component that can be programmed or with an integrated processor for executing software, for example an integrated circuit, a chip card, a memory card, an electronic card for executing firmware, etc.

Each component of the system described above of course implements its own software modules.

The various examples of implementations mentioned above can be combined with one another for the implementation of the disclosure.

### 4. DRAWINGS

Other features and advantages of the disclosure will appear more clearly upon reading the following description of a preferred example of embodiment, given as a simple illustrative and non-limiting example, and from the appended drawings, wherein:

FIG. 1 schematically describes the method implemented;

FIG. 2 describes two situations for processing pixel data from sensors for producing an HDR stream of rate equivalent to the rate of the SDR sensors;

FIG. 3 illustrates an architecture of a device capable of implementing a method subject matter of the disclosure;

FIG. 4 illustrates the implementation at the same time of the method, subject matter of the disclosure.

### 5. DESCRIPTION

As disclosed above, the method for producing an HDR video stream of the disclosure comprises combining, from at least three SDR video streams, images constituting these SDR streams. Indeed, as an SDR camera is not capable of capturing the entire dynamic range of the scene, it inevitably loses details in the poorly lit (black-saturated pixels) and highly lit (white-saturated pixels) areas. The data thus acquired are then more difficult to use by artificial vision applications. Therefore, there is a significant need for extended dynamic range cameras that can be used in varied application fields (e.g. video surveillance, autonomous vehicle or industrial vision), at a lower cost than the existing solutions and that can produce an HDR stream in real time.

The method developed by the inventors aims to address this issue. It is more particularly based on the use of standard, inexpensive sensors, and on the implementation of a management adapted to a memory for temporarily storing pixel data from these sensors, this memory acting as a synchronisation pivot between the real-time acquisition and the production, also in real time. More particularly, according to the disclosure, at least two sensors are used at the same time, these two sensors making it possible to generate, simultaneously, two images, which are saved within a temporary storage space, comprising at least three storage locations. According to the disclosure, the generation of images and their saving within the temporary storage space are carried out as a minimum at the speed for generating images coming from the sensors. Yet more specifically, the plurality of sensors are mounted within a plurality of cameras (one sensor within one camera). According to the disclosure, these cameras are for example all of the same type. The cameras are for example configured to produce an image stream at 60 images/second. That said, each image produced by a camera is exposed over a maximum time (i.e. integration time) before the sensor is read, by destructive read out. When the cameras are configured to produce an image stream at 30 images/second, each image produced by a camera is exposed over a maximum time (i.e. integration time) before the sensor is read, by destructive read out. Thus, the period T= 1/60^{th} of a second comprises an integration time to which a sensor readout time is added and possibly a waiting time. The integration time is directly related to the brightness of the scene and may be less than the millisecond for sufficiently bright scenes. The readout time is related to the technology of the readout circuit of the sensor. The readout is carried out over the period T= 1/60^{th} of a second. When the integration time is sufficiently short, then the addition of the integration and readout times < 1/60^{th} of a second and a waiting time occurs (up to max. 1/60^{th} of a second). If the integration time is too long then it is required to reduce the readout speed to 1/30^{th} of a second for example so as not to truncate the acquisitions. Therefore in the end, the sensor may have a speed of 1/60^{th} of a second and consequently, to preserve the rate the integration time is between 0 and ( 1/60^{th} of a second−read_out_time). The same logic applies for sensors at 1/30^{th} of a second.

Regardless of the image production speed, the latter determines a maximum exposure time for each image before being produced. As one object of the proposed method is to deliver an HDR stream that is produced at the same speed as that of the cameras, it is therefore necessary to produce HDR images at the speed at which the images are produced by the cameras: the maximum exposure time of the images is therefore less than the speed for producing these images by the sensor. As described hereinafter, the exposure time of each image is configured throughout the execution of the method for producing the HDR stream to make sure that the latter is consistent with the exposure time needed relating to each image.

The method implemented is described in relation to FIG. 1. It comprises a plurality of overall iterations of creating high dynamic range images comprising:

determining (D1) at least three sensor exposure times comprising: a short exposure time TC, a long exposure time TL and an intermediate exposure time TI, such that TC<TI<TL;

at least one iteration of reading (D2) sensors, from said at least two sensors, delivering at least three successive images (IC, II, IL), depending on said at least three sensor exposure times (TC, TI, TL); the number of iterations of this step (D2) depends on the number of available sensors: two sensors for three images implies two iterations at least, three sensors for three images implies one iteration for each sensor; other configurations are explained hereinafter; saving (D3), within at least three dedicated memory areas (ZM #1, ZM #2, ZM #3), said at least three successive images (IC, II, IL), each memory area being dedicated to a sensor exposure time from said at least three sensor exposure times;
generating (D4) a high dynamic range image from information extracted from said at least three successive images (IC, II, IL) saved respectively within said at least three dedicated memory areas (ZM #1, ZM #2, ZM #3);

adding (D5) said high dynamic range image to said HDR video stream.

The method may be implemented so that the method being implemented so that at any moment an image acquired at the short time (IC), an image acquired at the intermediate time (II) and an image acquired at the long time (IL) are respectively present within said at least three dedicated memory areas (ZM #1, ZM #2, ZM #3). The method may be implemented by means of two processes operating at the same time: a production process, comprising the iterations of steps D1 to D3, which ensure a continuous production of images in the dedicated memory areas and a stream generation process that uses indifferently and continuously the images present in the memory areas dedicated to implementing the iterations of steps D4 and D5. Other possible implementations can also be envisaged, for example by performing a different number of iterations in step D2: instead of three iterations, only two captures may be carried out (one capture on each sensor), making it possible to fill the memory areas corresponding to each of the two captures (for example ZM #1, ZM #2), then with the following overall iteration, again two captures only are performed making it possible to fill the memory areas corresponding to each of the two captures (for example ZM #2, ZM #3). Other implementations can also be envisaged depending particularly on the number of available cameras, as explained hereinafter.

More particularly, combining the acquired images is performed in real time, when the latter are produced. The system for implementing this combination technique comprises at least two cameras, each camera being equipped with a sensor that is able to capture a scene at a given speed and resolution. The system comprises a processing unit, which is configured to extract, from these at least two cameras, the at least three SDR video streams. The processing unit also comprises at least three memory areas, intended to receive at least three different images, each image being from one of the three SDR video streams. The processing unit carries out a combination of the three images of the three different memory areas to produce an HDR image from the three SDR images of the three memory areas. Each of the three images saved in the three different memory areas is from a different exposure time of a camera sensor. For example, when two cameras are used, a first image 11 is obtained for an exposure time d1, a first image 12 is obtained for an exposure time d2 and a third image 13 is obtained for an exposure time d3, so that d1<d2<d3. According to the present disclosure, it is ensured that d3 is less than the image production rate of the cameras. For example, if the camera produces 60 images/second, it is ensured that:

$$d 1 < d 2 < d3 ≪ \frac{1}{60} s .$$

In addition, it is also ensured, in this use case of two cameras and therefore of two sensors, that

$$( d 1 + d2 ) ≪ \frac{1}{60} s .$$

III> securiu cununuon making it possible to ensure that it is possible to produce three images with at least two cameras, the three images being produced at most at the image production speed of the camera.

Thus, using two (at least) standard cameras (non HDR), the proposed production method makes it possible to obtain at least three images from the same scene to be captured and to provide three streams, which are processed in real time to provide a single HDR video stream. Of course, what is possible with two cameras is also possible with three or more cameras, as described hereinafter. The principle of the proposed method being to have, at each moment, within the three memory areas, an image (one image per memory area), each of these three images having been captured with a different exposure time (a “short” time, a “long” time and an “intermediate” time, which is determined from the “short” time and from the “long” time).

According to the disclosure, there are at least two ways to determine the exposure times: by carrying out a calculation of the short times and long times to minimise the black and white saturations and subsequently by determining an intermediate time (for example in the sqrt(TC*TL)) form; or by carrying out a calculation of the intermediate time with for example “the auto-exposure” of the camera or by another auto-exposure method to be implemented and subsequently “empirical” determination of the TC (short times) and TL (long times) by removing/adding one or more EV (exposure values).

According to the disclosure, the exposure times of each of the images are determined at least partially at each capture iteration. In other terms, at the nth capture iteration, “short”, “long” and “intermediate” exposure times are configured, an image is obtained by at least two cameras at each of these times (“short”, “long” and “intermediate”) and saved in the three memory areas: a first memory area for the image captured at the “short” exposure time, a first memory area for the image captured at the “intermediate” exposure time and a third first memory area for the image captured at the “long” exposure time. These three images are processed to provide an HDR image and this HDR image is added to the HDR stream. During the processing of these three images, a new evaluation of the “short”, “long” and “intermediate” exposure times is performed depending on the content of the three images of this nth iteration and these new “short”, “long” and “intermediate” exposure times are used to configure the “short”, “long” and “intermediate” exposure times of the following iteration (n+1), and so on, throughout the processing for capturing the HDR stream.

Thus, according to the disclosure, the values of the acquisition times are estimated at each new acquisition from statistical analyses carried out on the preceding acquisitions. For three acquisitions, an estimation is performed: the short time is estimated by minimising the number of white-saturated pixels (<10% for example); the long time is estimated by minimising the number of black-saturated pixels (<10% for example). The intermediate exposure time is subsequently estimated in a calculatory way: it may for example involve a simple calculation: square root of the product of the long time and of the short time.

According to the disclosure, the short and long times are estimated depending on a plurality of factors, particularly that of the image frequency of the HDR stream. Indeed, unlike techniques concerning the production of HDR pictures, wherein multiple images may be obtained and selected depending on the desired quality, the creation of an HDR video stream needs to adapt continuously to brightness variations of the scene that need to be rapidly evaluated and taken into account. Therefore, the earlier techniques wherein the best images are selected from a plurality of available images (as in the patent document FR3062009) are not applicable for creating an HDR video stream, because they require having a surplus number of images, on which the selection of images to be kept is made. Thus, according to the disclosure, a rapid evaluation of the short and long exposure times is carried out. More particularly, the step of evaluating these exposure times (short and long) is based on the histograms of previously acquired IC (short exposure time) and IL (long exposure time) images. The histograms make it possible to have an accurate estimation of the distribution of the pixels. If the number of white-saturated pixels (pixels of value greater than 240 for 8-bit images for example) of the IC image is too high (more than 10 to 15% for example), then the exposure time of the IC image at the next iteration must be reduced to be able to capture more information in the highly lit areas. On the other hand, if the number of white-saturated pixels is very low (less than 2% for example), then the exposure time may be increased to avoid too large a difference with the intermediate image, which would result in an information “hole” in the dynamic. Similarly, if the number of black-saturated pixels (pixels of value less than 16 for 8-bit images for example) of the IL image is too high, then the exposure time of the IL image at the next iteration must be increased. Finally, if the number of black-saturated pixels of the IL image is too low, then the exposure time of the IL image at the next iteration must be reduced. The variations in exposure times from one iteration to another may be expressed in the form of exposure value (EV): an increase (respectively reduction) of one exposure value unit (1 EV) is translated by a multiplication (respectively division) by two of the exposure time. In the case where the number of saturated pixels is very high, it is possible to increase or reduce by 2EV (factor 4 over the exposure time) and on the contrary, in the case where it is desired to refine the number of saturated pixels around selected thresholds, it is possible to limit the variations to ½ EV (a half), or even ⅓ EV (a third).

These calculations made at each acquisition make it possible to very rapidly take into account all of the lighting changes of the scene. According to the disclosure, the long exposure time is adjusted depending on the number of cameras (and therefore of sensors) used for populating the three memory areas. For example, if there are six sensors at 1/30 see the acquisitions of which are offset over time, it is possible to increase the output rate. The principle being that as soon as there are three images, the processing of other acquisitions can be carried out at the same time.

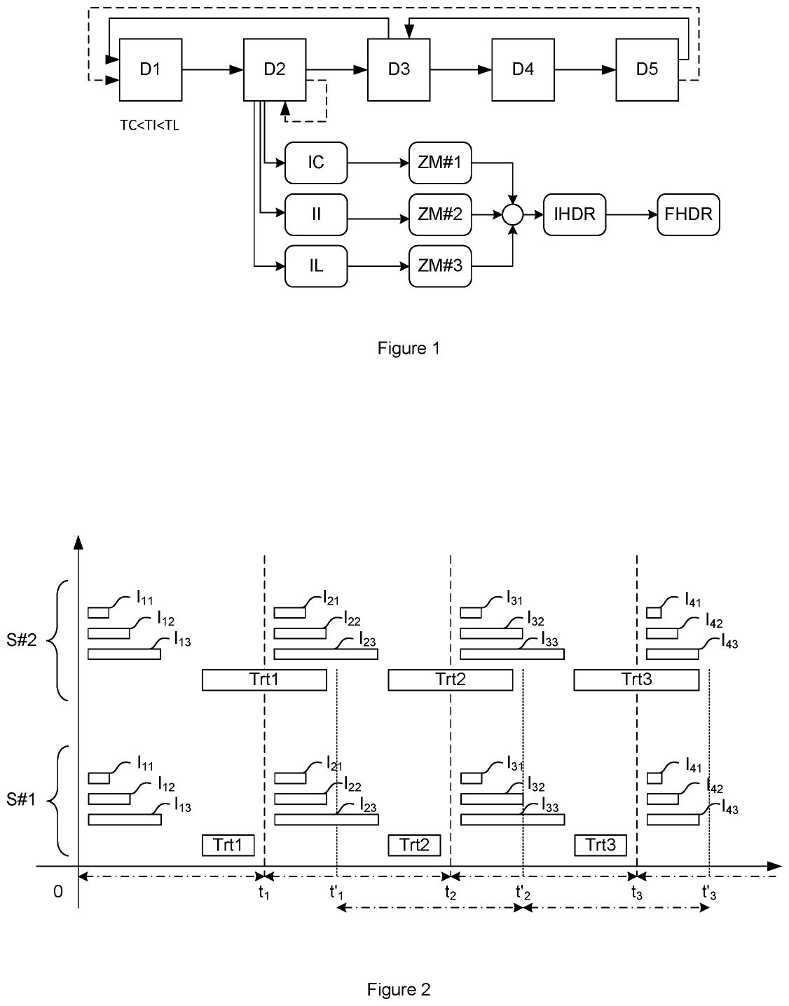

In relation to FIG. 2, two situations are described for processing SDR images to produce HDR images, as disclosed in FIG. 1. In this example, the width of the bars representing the images is representative, approximately, of the short, intermediate and long times for the exposure of each image.

In the first situation S #1, the implementation of the method for creating an HDR stream, from three SDR streams, is described. It is assumed in this first situation that the three SDR streams are respectively obtained by three different sensors (three cameras). The images 111, 121, 131 and 141 are images obtained at short integration times, the images 112, 122, 132 and 142 are images obtained at intermediate integration times and the images 113, 123, 133 and 143 are images obtained at long integration times. In this first situation, processing for creating an HDR image from three SDR images (Trt1, Trt2, Trt3) is implemented subsequent and sequentially to the acquisition of the images. Each processing (Trt1, Trt2, Trt3) follows an identical implementation (deghosting of pixels, combining of SDR images) and identical processing times are illustrated for greater simplicity. The times t1, t2 and t3 represent the maximum frame rate of SDR cameras (for example 60 imgs/see, 30 imgs/see, etc.).

In the second situation S #2, it is still assumed that the three SDR streams are respectively obtained by three different sensors (three cameras). Processing for creating an HDR image from three SDR images (Trt1, Trt2, Trt3) is implemented subsequent to and at the same time as the acquisition of the images. This is the main difference with situation #1. Processing is desynchronised from the acquisition. The only constraint is to make sure that the processing on the images acquired at tare shorter in time than the acquisition of t+1. Thus, by using as many sensors as there are images to be acquired (typically three), the cycle time is as a minimum equal to the time for acquiring the image with the long integration time. By using more sensors (for example four instead of three), it can be envisaged to dedicate two of these four sensors to the acquisition of images at long times of which the acquisition starts would be offset by a half period. For example, with a period of 1/30, the first sensor would provide images every 1/30 of a see, by starting at t= 1/60, whereas the second sensor could provide images at t=n+ 1/30+ 1/60: it is thus possible to produce images every sixtieth of a second. The operational implementation conditions determine the strategy to be adopted, particularly depending on the cost of sensors that are high-performance and have a better acquisition speed (but more expensive) vs. a higher number of sensors (four, five or six) but individually less expensive.

Each processing (Trt1, Trt2, Trt3) follows an identical implementation (deghosting of pixels, combining of SDR images) and identical processing times are illustrated for greater simplicity. The times t1, t2 and t3 represent the maximum frame rate of SDR cameras (for example 60 imgs/see, 30 imgs/see, etc.).

In the first situation S #1, an HDR image is obtained from the first iteration, after the time period of 0 to t1, and so on. In the second situation S #2, an HDR image is only obtained from the time t′2, then t′3 and so on. Therefore, there is a slight offset during the production of the first HDR image. This offset upon startup finally makes it possible to take advantage of a longer time to carry out the processing for creating the HDR image without reducing the image production rate. In practical terms, the offset between t1 and t′1 corresponds to the time for processing the HDR image that initially exceeds the image production rate of the camera (i.e. “frame rate”). Thus, without changing the image production frequency, it is possible to have a processing time equal to the image production rate of the cameras as input: at most the time separating t1 and t′1 will be equal to one cycle.

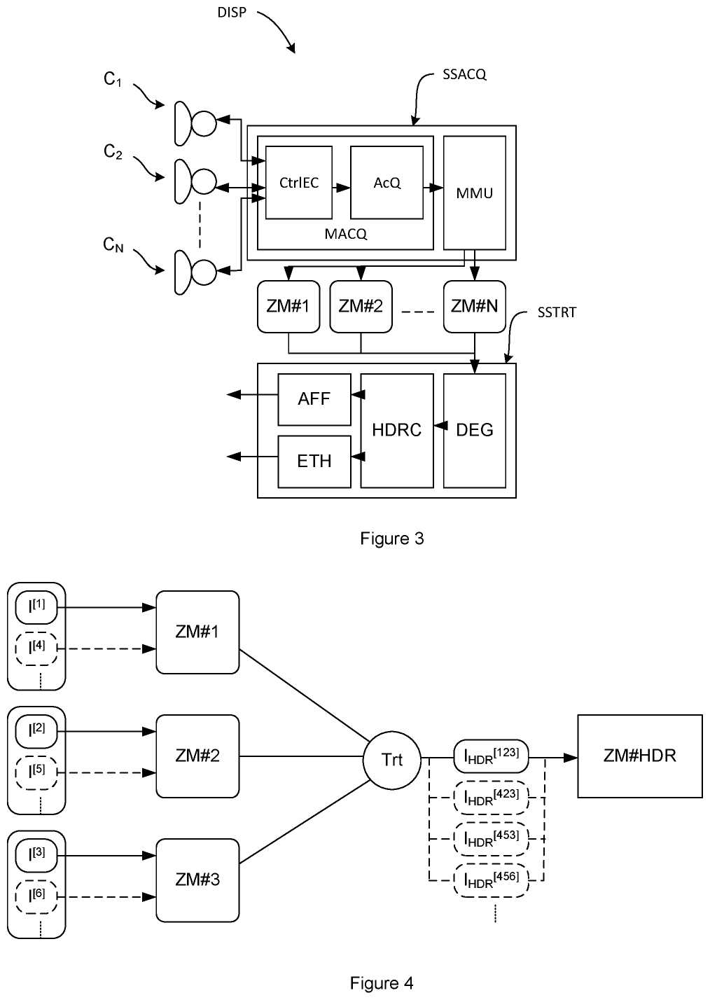

In relation to FIG. 3, an example of implementation of a device (DISP) for implementing the method for creating an HDR stream is described according to an example of embodiment. Such an HDR stream acquisition device, also called HDR camera, comprises an acquisition subunit (SSACQ) that firstly comprises N sensors (C1, . . . CN). The sensors are connected to an acquisition model (MACQ) comprising two submodules: an exposure time programming submodule (CtrIEC), which is used to configure the exposure times of each sensor and an acquisition (AcQ) submodule strictly speaking that is in charge of reading, for each sensor, the matrix of pixels of this sensor and transmitting, to the memory management unit (MMU) module, the acquired pixel datasets. As indicated above, it is necessary to change the exposure time at each new acquisition by a camera, and this in order to rapidly adapt to the changing exposure conditions of the scene that is filmed. Typically, for three images, there is an Image 1 with short time, an Image 2 with intermediate time, an Image 3 with long time, then subsequently an Image 4 with short time, an Image 5 with intermediate time, an Image 6 with long time, etc. The values of the acquisition times are estimated at each new acquisition from statistical analyses carried out on the preceding acquisitions, as explained above. These calculations made at each acquisition make it possible to very rapidly take into account all of the lighting changes of the scene. Once the exposure times have been determined, the acquisition (ACQ) submodule can programme the sensor(s), launch the acquisition and subsequently retrieve the image thus acquired by the corresponding sensor.

The memory management unit (MMU) module, for its part, receives, from the acquisition module, the pixel datasets. Each pixel dataset relates to an image acquired by a sensor. The pixel data are provided by the acquisition module with an identifier, making it possible to determine the source sensor or also the exposure times or both of these two data. The memory management unit (MMU) module saves the pixel datasets obtained in the memory areas (ZM1, . . . , ZMN) depending on the exposure time, of the source sensor or of these two combined items of information.

More particularly, regardless of the number of sensors, the inventors developed a specific device for managing the memory that makes it possible to continuously have at least three images stored in the memory, each one of them having a short, intermediate or long exposure time. Upon startup (initial iteration), the acquisition of the image 1 (short time) in the memory 1 is carried out. The image 2 (intermediate time) in the memory 2, then the image 3 (long time) in the memory 3. At the following iteration, for storing the image 4 (short time), the MMU module overwrites the oldest image (image 1—short time). For the image 5 (intermediate time), the image 2 is overwritten. With this device, after each new sensor acquisition (regardless of the sensor used for the acquisition), the last three images acquired with a short, intermediate and long time are in the memory.

At the same time as the acquisition, the MMU module carries out the reading of images in order to populate the processing subunit (SSTRT) (see hereinafter). The advantage of this write/readout approach in a plurality of circular memories is to be able to generate HDR images at the same rate as the sensor: at each new acquisition, regardless of the source sensor, there is a sufficient amount of data in the memory to generate a new HDR image in the HDR video stream.

In the case of a device with many sensors, the MMU module is implemented to synchronise the various acquisitions carried out at the same time. At each new acquisition, at least one of the three memories is updated with a new image, so that as in the preceding case, the HDR generation is carried out at the acquisition speed.

In any case, the inventors chose to work in real time on the data stream acquired by the sensors.

It is also possible to desynchronise (situation #2, FIG. 2) the two streams (acquisition stream and processing stream) by using twice as much memory. The first part of the memory being used for storing the images to be acquired and the second for processing the images already acquired. As soon as the processing carried out on the second part of the memory has finished, it is possible to switch the memories and to start the processing on the first part of the memory (containing the most recent image acquisitions) whereas the second part of the memory is used for carrying out the following acquisition. This solution has not been retained, in this example of implementation, because the processing performed is temporarily possible with the acquisition (however, with greater acquisition frequencies, this solution could be of interest). Indeed, in this example of implementation, the processing executed can be performed in the acquisition stream, that is to say simultaneously with the readout of the new image and the readout of the images already saved. The new image acquired by the sensor is transferred from the sensor to the MMU line by line. The processing module SSTRT is capable of processing line at the same time all of the pixels of the line read with the pixels of the corresponding lines in the two other stored images. The time for processing each pixel is much less than the rate for providing a complete line of pixels, which makes it possible to produce a new line of HDR pixels for each new line of acquired pixels.

If it is envisaged to perform more complex processing (to improve the quality of the HDR images or to carry out post-processing on the HDR stream, such as the detection/recognition of objects for example), a dual-memory system could be envisaged.

The HDR stream acquisition device also comprises a processing subunit (SSTRT). This processing subunit carries out the processing of images saved in the memory areas, continuously, at the theoretical speed for capturing frames by the sensors (e.g. 60 images/see, 30 images/see, etc.), in order to produce an HDR stream having the same rate as the production rate of the sensors.

This processing subunit (SSTRT) comprises, in this example of embodiment, a deghosting module (DEG), the function of which is to perform a possible deghosting of pixels corresponding to moving objects, when such objects exist in the scene to be captured. The deghosting module (DEG) uses the N (e.g. three) acquired images to estimate the movement of objects within these N images. This estimation is carried out for all of the pixels. Inevitably, there is more movement in the case of the acquisition with two sensors since the acquisitions are carried out sequentially (in general, when it is desired to obtain n acquisitions and when there are only at most n−1 sensors, there are sequential acquisitions). In the multiple sensor case (more than two), the movements are minimised (mainly from blurring, increasing with the exposure time) due to the simultaneous acquisition. In any case, when a movement is detected, an algorithm for correcting this movement is executed on the pixels concerned before transmitting them to the HDR creation module. The inventors evaluated a plurality of possible algorithms. However, in order to make an HDR production possible in real time (i.e. at the frame rate of N sensors used for capturing the images) two algorithms are implanted on the device: the pixel order method and the weighting function method: these two methods give satisfactory results while limiting the processing times. Selecting these methods is related to the fact that they are compatible with the rapid calculation requirements in order to be capable of detecting and correcting the movement artefacts at a rate greater than that of the acquisition.

When no movement is detected, then the N sets of raw pixels (corresponding to the N images) are transmitted directly to the HDR creation (HDRC) module. The HDR creation (HDRC) module uses the N streams at the same time to evaluate the HDR value of each of the pixels. The method used uses the “Debevec and Malik” algorithm, which is adapted to the device so that it is more efficient in processing time.

The Debevec method is based on the fact that a pixel of a visual scene has a constant irradiation value and that it is possible to estimate this irradiation from the values of the pixels obtained with different acquisition times and from the transfer curve of the camera used. The mathematical equations of the Debevec method require calculating the logarithm of the inverse of the transfer function of the camera. According to the disclosure, in a real-time context, for efficiency reasons, all of the values of this logarithm have been precalculated for all possible pixel values (between 0 and 255 for an 8-bit sensor, between 0 and 1,023 for a 10-bit sensor) and stored in a memory of the system, the calculation subsequently being limited to a single readout of a memory bin. Such an implementation makes it possible to ensure real-time processing of the streams.

Once the HDR image has been produced, it must be possible to use it. This can be done in two ways:
Display on screen (using a display module AFF);
Raw output (towards a communication network, using an appropriate module ETH).

As regards the on-screen display, it is not possible to display HDR data on a traditional screen. Indeed, a traditional screen accepts whole pixel values generally coded over 8 to 10 bits for each RVB channel. In the case of the HDR production, a real video stream coded over 32 bits is produced. Therefore, it is necessary to “compress” the format so that it is acceptable by a screen. This is what the display module AFF (Tone mapping) does. The implanted algorithm is selected specifically by the inventors. There are two large “tone mapping” algorithm families: firstly, the local algorithms exploit the local vicinity of each pixel to adapt their processing and produce a high quality “tone mapping”. The local algorithms require complex computations resulting in significant hardware resource requirements and often incompatible with the real-time constraints. Secondly, the overall algorithms use processing common to all pixels, which simplifies their real-time implementation but to the detriment of the overall quality of the result obtained. Thus, with regard to the real-time processing requirement, the inventors selected an algorithm of the type of that described in Duan et al (2010), that they have adapted to the implementation conditions described above.

As regards the network output (ETH), an Ethernet network controller for outputting the non-compressed HDR streams at the speed where they are produced is implemented. Such a controller particularly makes it possible to be able to evaluate the quality of the algorithms for producing the HDR stream with metrics.

FIG. 4 illustrates another example of implementation, wherein the pivot function of the memory areas is diverted to produce an HDR stream at a higher rate substantially close to that of the sensor of the SDR camera. In other terms, in this example of embodiment, it is possible to produce an HDR stream at a higher rate (in number of images per second) than those of the SDR camera used to film the scene. For this, the memory areas storing the various images are used in a desynchronised way, depending on the programming carried out over the exposure times of the camera by the exposure time programming submodule (CtrlEC) that has been described above. This technique can also be used with two cameras, as has been disclosed above.

By way of example for the explanation provided in relation to FIG. 4, it is considered that only one sensor (a single sensor) is used to produce three SDR streams, each stream having a speed of 20 images per second (i.e. 60 images per second divided by three). Each exposure of each image is therefore less than 1/60^{th} of a second. In this example, however, an HDR video is produced comprising as a minimum 60 images per second. For this, as explained in the general case, the images are saved in a memory area and the processing for deghosting pixels and for combining HDR images is carried out in real time when the images are read in the memory areas ZM #1 to ZM #3. It will be noted that this mode of using the pivot function of the memory areas is well adapted to the implementation of the processing for producing an HDR stream in a use case where the one and only SDR sensor is present to carry out the capture of the SDR stream.

In this example of FIG. 4, at the first capture iteration, an image I[1], with short time, is captured by the sensor of the acquisition subunit SSACQ. This image is stored in the memory area ZM #1 by the MMU module. At the second capture iteration, an image I[2], at the intermediate time, is captured by the sensor. This image is stored in the memory area ZM #2. At the second capture iteration, an image I[3], at the long time, is captured by the sensor. This image is stored in the memory area ZM #3. As the three memory areas each have an image (short time, intermediate time and long time), the processing subunit retrieves these three images in memory and carries out the conversion into HDR image (IHDR[123]). The first HDR image therefore has been obtained in a capture of

$$3 \times \frac{1}{60} s = \frac{1}{20} s ,$$

to which une processing time is added by the processing subunit (<<at 1/60^{th} of a second) for the conversion into HDR image.

At the same time, the sensor of the acquisition subunit SSACQ carries out a capture of a new image I[4], at short time, which is stored in the memory area ZM #1 by the MMU module. As the three memory areas again each have an image (short time I[4], intermediate time I[2] and long time I[3]), the processing subunit retrieves these three images in memory and again carries out the conversion into HDR image (IHDR[423]). The second HDR image therefore has been obtained in a capture <<at 1/60^{th} of a second.

At the same time, the sensor of the acquisition subunit SSACQ carries out a capture of a new image I[5], at intermediate time, which is stored in the memory area ZM #2 by the MMU module. As the three memory areas again each have an image (short time I[4], intermediate time I[5] and long time I[3]), the processing subunit retrieves these three images in memory and again carries out the conversion into HDR image (IHDR[453]). Therefore, the third HDR image again has been obtained in a capture <<at 1/60^{th} of a second.

At the same time, the sensor of the acquisition subunit SSACQ carries out a capture of a new image I[6], at long time, which is stored in the memory area ZM #2 by the MMU module. As the three memory areas again each have an image (short time I[4], intermediate time I[5] and long time [6]), the processing subunit retrieves these three images in memory and again carries out the conversion into HDR image (IHDR[456]). Therefore, the third HDR image again has been obtained in a capture <<at 1/60^{th} of a second. This process is continued throughout the HDR stream capturing and conversion process and it delivers an HDR stream at 60 images per second. In this example of embodiment, an issue that may arise is the presence of artefacts. Therefore, it is often necessary to carry out pixel deghosting, which is not the case or less the case when two or more sensors are used.

In another example of embodiment, at least two identical sensors are used for implementing the disclosed technique. These at least two sensors, although identical, are each programmed to operate at different capture speeds. More particularly, it has been disclosed above that the exposure time programming submodule (CtrIEC) carried out a programming of the maximum exposure time of the sensors in order to obtain a short time, a long time and an intermediate depending on the long time. These exposure times are shorter (or even much shorter) than the production rate of the camera. For example, in the case of a production rate at 120 images per second, the short time may be 1/500^{th} of a second, the intermediate time at 1/260^{th} of a second and the long time at 1/140^{th} of a second). Yet, it has been indicated above that the object of the short and long times was to minimise the presence of respectively white- or black-saturated pixels (number of pixels less than a given percentage for all of the pixels of the image). Yet, it may happen that in some situations, the maximum exposure time of 1/120^{th} of a second is not sufficient to minimise the black-saturated pixels. Thus, in an additional example of embodiment, the at least two sensors are configured so that they produce SDR images at different production rates. More particularly, one of the sensors is configured to produce images at the rate of 120 images per second, whereas the other sensor is configured to produce images at the rate of 60 images per second. The second sensor produces images at a lower speed, but benefits from a longer exposure time. The downside is that it may then produce images more efficiently wherein the quantity of black-saturated pixels is lower than the predetermined value (for example 10%). In this situation, it is then possible to produce two types of HDR stream, depending on the available computation resources: the first type of HDR stream is set at a rate of 60 images per second, that is to say the “lowest” possible value, based on the production rate of the sensor configured to be the least rapid. The advantage of this solution is that there is less pixel deghosting processing due to the presence of artefacts. Another advantage is to be able to use only two sensors: the sensor operating at a rate of 120 images per second makes it possible to carry out two captures during the capture time at long time; the first sensor obtains the image at short time and the image at intermediate time while the second sensor obtains the image at long time. When the three images are present in the three memory areas considered, the latter are obtained and processed by the processing subunit to produce only one HDR image, according to one or other of the situations of FIG. 4.

The second type of HDR stream is set at a rate of 120 images per second, that is to say the “highest” possible value, based on the production rate of the sensor configured to be the most rapid. In which case, the method as described in FIG. 4 is implemented. Each new image obtained by the sensor the production rate of which is the rate of 120 images per second is used, immediately, to carry out the computation of a new HDR image. In this situation, a current image of the sensor set at a rate of 60 images per second will be used to produce two images of the HDR sensor stream.

1. Method for generating a video stream comprising a set of high dynamic range images, called HDR video stream, from a plurality of standard dynamic range images that are obtained by reading at least two image sensors each having an image production rate, each sensor comprising a plurality of pixels arranged in a matrix, and each associated with a photoelectric conversion element for converting received light into electric charge and accumulating said electric charge over a light exposure time, method comprising a plurality of iterations of creating high dynamic range images comprising:
determining (D1) at least three sensor exposure times comprising: a short exposure time TC, a long exposure time TL and an intermediate exposure time TI, such that TC<TI<TL;
at least one iteration of reading (D2) sensors, from said at least two sensors, delivering at least three successive images (IC, II, IL), depending on said at least three sensor exposure times (TC, TI, TL);
saving (D3), within at least three dedicated memory areas (ZM #1, ZM #2, ZM #3), said at least three successive images (IC, II, IL), each memory area being dedicated to a sensor exposure time from said at least three sensor exposure times;
generating (D4) a high dynamic range image from information extracted from said at least three successive images (IC, II, IL) saved respectively within said at least three dedicated memory areas (ZM #1, ZM #2, ZM #3);
adding (D5) said high dynamic range image to said HDR video stream, the method being implemented so that at any moment an image acquired at the short time (IC), an image acquired at the intermediate time (II) and an image acquired at the long time (IL) are respectively present within said at least three dedicated memory areas (ZM #1, ZM #2, ZM #3).

2. Method for generating an HDR video stream according to claim 1, characterised in that said determination of said at least three sensor exposure times (TC, TI, TL) comprises determining the intermediate exposure time TI depending on said short exposure time TC and on the long exposure time TL.

3. Method for generating an HDR video stream according to claim 1, characterised in that the short exposure time (TC) is calculated so that it produces, during the reading of a sensor from said at least two sensors, a standard dynamic range image of which a percentage of white-saturated pixels is less than a predetermined threshold.

4. Method for generating an HDR video stream according to claim 1, characterised in that the long exposure time (TL) is calculated so that it produces, during the reading of a sensor from said at least two sensors, a standard dynamic range image of which a percentage of black-saturated pixels is less than a predetermined threshold.

5. Method for generating an HDR video stream according to claim 1, characterised in that the intermediate exposure time (TI) is obtained as the square root of the product of the short exposure time (TC) and of the long exposure time (TL).

6. Method for generating an HDR video stream according to claim 1, characterised in that the long exposure time (TL) is less than the image production rate of at least one of said sensors from said at least two sensors.

7. Method for generating an HDR video stream according to claim 1, characterised in that the generation of a high dynamic range image of a current iteration of creating a high dynamic range image is implemented from information extracted from at least three current successive images (IC, II, IL) and is implemented at the same time as said iterations of reading sensors, from said at least two sensors, delivering at least three successive images (IC, II, IL) of the following iteration of creating a high dynamic range image.

8. Method for generating an HDR video stream according to claim 1, characterised in that the image rate of the HDR stream is at least equal to the image rate of at least one image sensor from the said at least two image sensors.

9. Computer program product comprising program code instructions for implementing a method according to claim 1, when it is executed by a processor.

10. Device for generating a video stream comprising a set of high dynamic range images, called HDR video stream, from a plurality of standard dynamic range images that are obtained by reading at least two image sensors each having an image production rate, each sensor comprising a plurality of pixels arranged in a matrix, and each associated with a photoelectric conversion element for converting received light into electric charge and accumulating said electric charge over a light exposure time, characterised in that it comprises a calculation unit adapted to implement the steps of the method for generating an HDR video stream according to claim 1.
